(19) United States
(12) Patent Application Publication
(10) Pub. No.: US 2010/0141384 A1
(43) Pub. Date: Jun. 10, 2010

(54) BOTTLE CAP HAVING ANTI-COUNTERFEIT FUNCTION AND BOTTLE USING THE SAME

(76) Inventors: Yeh-Shun CHEN, Kaohsiung (TW); Jung-Jie Liou, Kaohsiung (TW); Yung-Jen Chen, Kaohsiung (TW); Yuan-Li Tai, Kaohsiung (TW); Kuen-Shiuh Yang, Kaohsiung (TW)

Correspondence Address: Guice Patents PLLC, 12647 Galveston Court #302, Manassas, VA, 20112, US

(21) Appl. No.: 12/328,292

(22) Filed: Dec. 4, 2008

(51) Int. Cl. H04B 7/00

(52) U.S. Cl. 340/10.1

(57) ABSTRACT

A bottle cap having anti-counterfeit function comprises a cap body and an RFID tag. The cap body has a cap portion, a ring neck portion and at least one joint portion, there is an interval between the cap portion and the ring neck portion, and the joint portion crosses through the interval and couples the cap portion and the ring neck portion. The RFID tag is disposed at the cap body and has an antenna and a chip electrically connected with the antenna. The antenna has a first antenna portion, a second antenna portion and a third antenna portion, the first antenna portion and the chip are disposed at the cap portion of the cap body, the second antenna portion is disposed at the ring neck portion of the cap body, and the third antenna portion crosses through the interval and bridge connects the first antenna portion and the second antenna portion.

### FIELD OF THE INVENTION

The present invention relates to a bottle cap for covering a bottle, more particularly to a bottle cap having anti-counterfeit function.

### BACKGROUND OF THE INVENTION

There is a serious problem continuing to exist in today's market that criminal enterprises sale counterfeit product of pharmaceuticals or alcoholic drink of high-value. The counterfeit product, making use of the containers or bottles provided by the original manufacturer that are retrieved and then cleaned to use, is available for sailing as pretended to be produced by original manufacturer in market, resulting in harming consumer's health and damaging goodwill of legal original manufacturer. Therefore, a tag for anti-forge is provided to pack the container or bottle body and cover thereof so as to differentiate if the cover has been opened by viewing the tag is torn off or destroyed. However, since the anti-counterfeit tag is easy to make, anti-counterfeit effect cannot be obtained greatly.

### SUMMARY OF THE INVENTION

It is a primary object of the present invention to provide a bottle cap having anti-counterfeit function comprising a cap body and an RFID tag. The cap body has a cap portion, a ring neck portion and at least one joint portion, wherein there is an interval between the cap body and the ring neck portion, the joint portion crosses through the interval and couples the cap portion and the ring neck portion. The RFID tag disposed at the cap body has an antenna and a chip electrically connected with the antenna. The antenna has a first antenna portion, a second antenna portion and a third antenna portion connecting with the first antenna portion and the second antenna portion, wherein the first antenna portion and the chip are disposed at the cap portion of the cap body, the second antenna portion is disposed at the ring neck portion of the cap body, the third antenna portion crosses through the interval and bridge connects the first antenna portion and the second antenna portion. When turning the bottle cap having anti-counterfeit function which is disposed at a bottle body, the ring neck portion cannot rotate in company with the cap portion because a block protrusion of the ring neck portion leans against at least one stopper of the bottle body, and also the joint portion will break at the cap portion or the ring neck portion because the joint portion crosses through the interval and couples the cap portion and the ring neck portion. Besides, since that the first antenna portion and the chip are disposed at the cap portion, the second antenna portion is disposed at the ring neck portion and the third antenna portion crosses through the interval and bridge connects the first antenna portion and the second antenna portion, the third antenna portion will break and disconnect with the first antenna portion or the second antenna portion when turning the bottle cap having anti-counterfeit function, that results in failing of electrical function, in which case reader is unable to read each data stored in the RFID tag, thereby differentiating if the bottle cap having anti-counterfeit function has been opened.

### DESCRIPTION OF THE DRAWINGS

FIG. 1 is a perspective view of a bottle cap having anti-counterfeit function in accordance with an embodiment of the present invention.

FIG. 2 is another perspective view of the bottle cap having anti-counterfeit function in accordance with an embodiment of the present invention.

FIG. 3 is a sectional view of the bottle cap having anti-counterfeit function taken along line A-A of FIG. 1 in accordance with an embodiment of the present invention.

FIG. 4 is a perspective view of the bottle cap having anti-counterfeit function integrated with a bottle body in accordance with an embodiment of the present invention.

FIG. 5 is a perspective view of the bottle cap having anti-counterfeit function which is turned to open in accordance with an embodiment of the present invention.

FIG. 6 is a sectional view of the bottle cap having anti-counterfeit function taken along line B-B of FIG. 5 in accordance with an embodiment of the present invention.

FIG. 7 is another perspective view of the bottle cap having anti-counterfeit function in accordance with another embodiment of the present invention.

### DETAILED DESCRIPTION OF THE PREFERRED EMBODIMENT

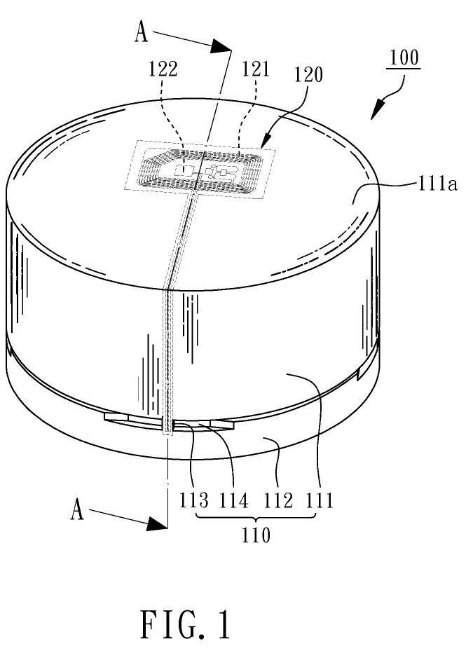

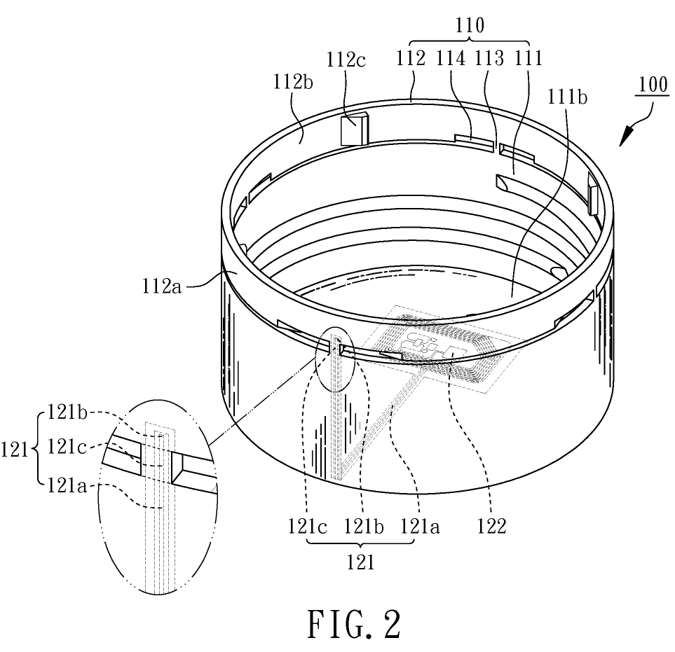

Referring to FIGS. 1 and 2, a bottle cap having anti-counterfeit function 100 in accordance with an embodiment of the present invention comprises a cap body 110 and an RFID tag 120. The cap body 110 has a cap portion 111, a ring neck portion 112 and at least one joint portion 113. There is an interval 114 between the cap portion 111 and the ring neck portion 112, and the joint portion 113 crosses through the interval 114 and couples the cap portion 111 and the ring neck portion 112. The RFID tag 120 has an antenna 121 and a chip 122 electrically connected with the antenna 121, the antenna 121 has a first antenna portion 121a, a second antenna portion 121b and a third antenna portion 121c connecting with the first antenna portion 121a and the second antenna portion 121b. The first antenna portion 121a and the chip 122 are disposed at the cap portion 111 of the cap body 110, the second antenna portion 121b is disposed at the ring neck portion 112 of the cap body 110, and the third antenna portion 121c crosses through the interval 114 and bridge connects the first antenna portion 121a and the second antenna portion 121b.

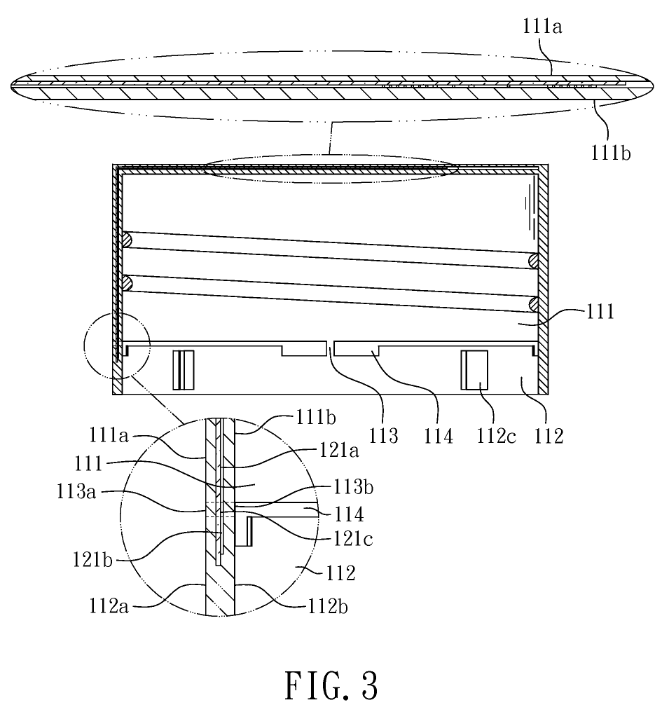

Next, referring to FIG. 3, the cap portion 111 has a first surface 111a and a second surface 111b, and the first antenna portion 121a and the chip 122 may be fixed between the first surface 111a and the second surface 111b or on the second surface 111b. The ring neck portion 112 has a third surface 112a and a fourth surface 112b, and the second antenna portion 121b may be fixed between the third surface 112a and the fourth surface 112b or on the fourth surface 112b. In this embodiment, the first antenna portion 121a and the chip 122 are fixed between the first surface 111a and the second surface 111b via molding method, the second antenna portion 121b is fixed between the third surface 112a and the fourth surface 112b via molding method. Moreover, referring again to FIGS. 1, 2 and 3, the third antenna portion 121c crosses through the interval 114 and is disposed to the joint portion 113 in this embodiment. The joint portion 113 has a fifth surface 113a and a sixth surface 113b, the third antenna portion 12 1c may be fixed between the fifth surface 113a and the sixth surface 113b or on the sixth surface 113b. In this embodiment, the third antenna portion 121c is fixed between the fifth surface 113a and the sixth surface 113b via molding method.

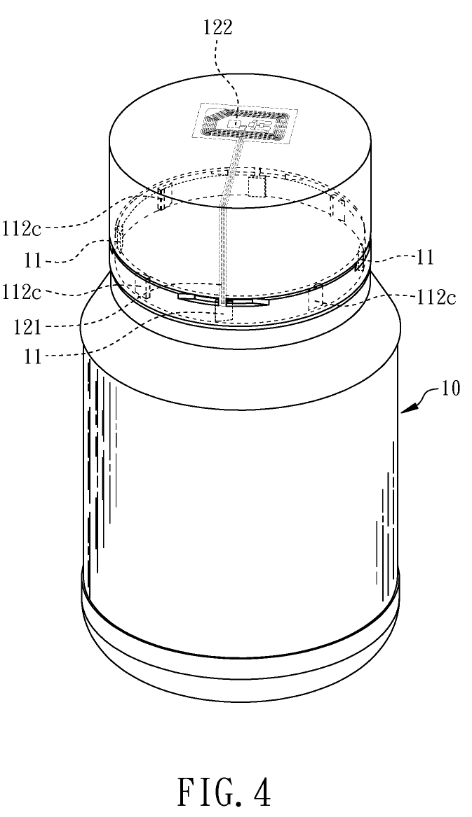

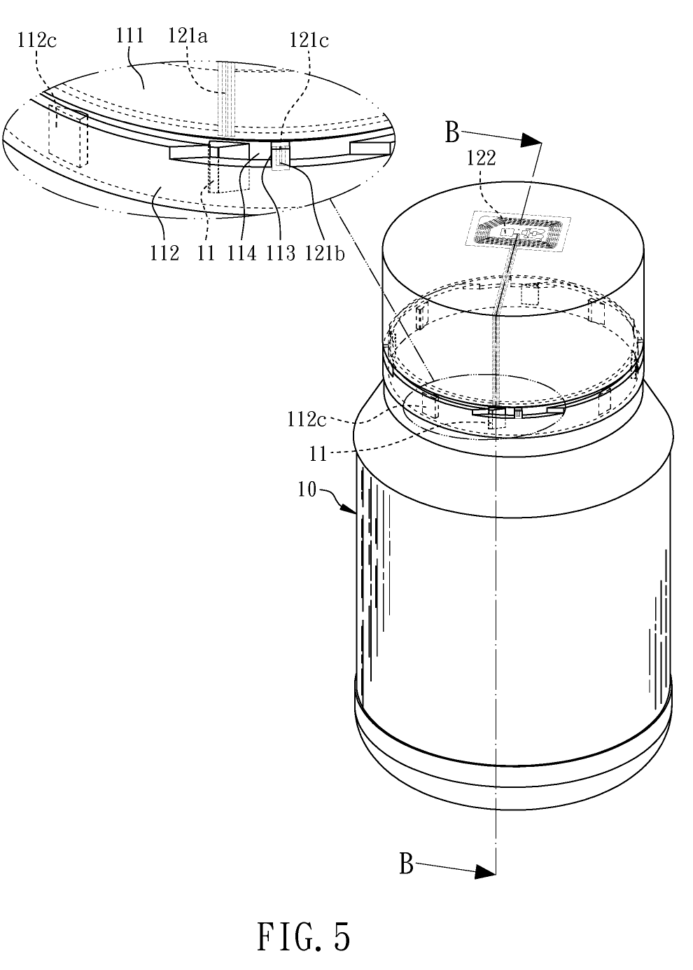

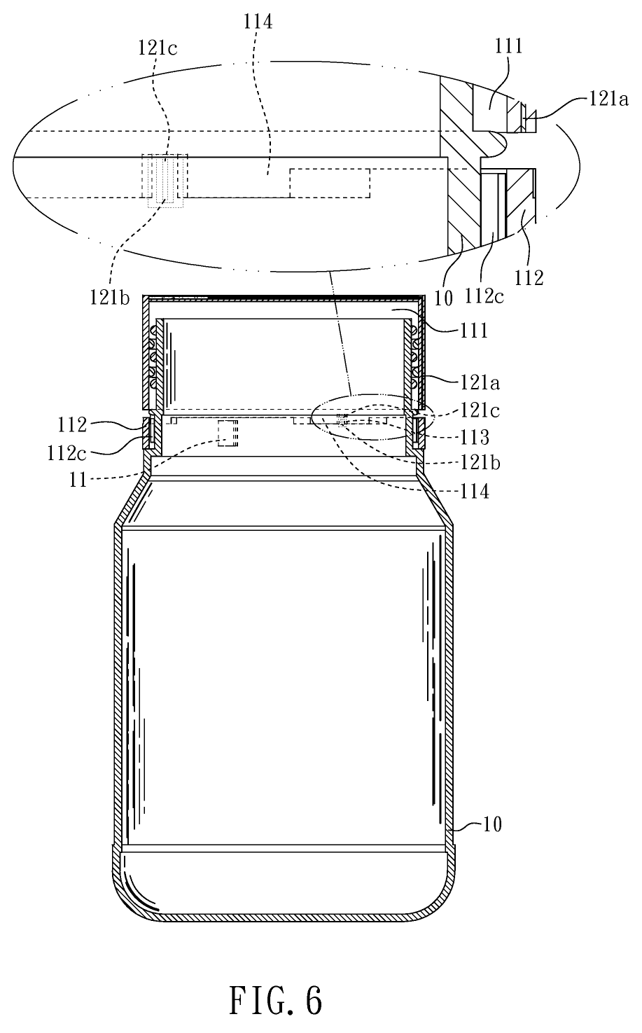

Next, referring to FIG. 4, the bottle cap having anti-counterfeit function 100 is disposed on a bottle body 10. The RFID tag 120 of the bottle cap having anti-counterfeit function 100 is capable of storing data about the contents of the bottle body 10, for example, manufacture date, ingredient, manufacture place and sales area, etc. In order to read each data stored in the RFID tag 120 via a reader (not shown in the drawing), such a configuration of that the third antenna portion 121c crossing through the interval 114 is disposed at the joint portion 113 and bridge connected the first antenna portion 121a and the second antenna portion 121b and electrically connecting the chip 122, the first antenna portion 121a and the second antenna portion 121b is provided. Referring to FIGS. 2, 4, 5 and 6, the ring neck portion 112 of the cap body 110 has at least one block protrusion 112c located on the fourth surface 112b, the block protrusion 112c of the ring neck portion 112 will move and lean against at least one stopper 11 of the bottle body 10 when turning to open the bottle cap having anti-counterfeit function 100. Meantime, the stopper 11 is capable of blocking the ring neck portion 112 from moving to allow the ring neck portion 112 not to rotate in company with the cap portion 111, and the joint portion 113 might break at the cap portion 111 or the ring neck portion 112 because it crosses through the interval 114 and couples the cap portion 111 and the ring neck portion 112. In view of the configuration of that the first antenna portion 121a and the chip 122 are disposed at the cap portion 111, the second antenna portion 121b is disposed at the ring neck portion 112, and the third antenna portion 121c crosses through the interval 114 and bridge connects the first antenna portion 121a and the second antenna portion 121b, the third antenna portion 121c disposed at the joint portion 113 might break and disconnect with the first antenna portion 121a or the second antenna portion 121b resulting in failing of electrical function, then the reader cannot read each data stored in the RFID tag 120, which may differentiate if the bottle cap having anti-counterfeit function 100 has been opened. Furthermore, the cap portion 111 of the cap body 110, the ring neck portion 112 and the joint portion 113 are formed integrally, so that it may also easily differentiate if the bottle cap having anti-counterfeit function 100 has been opened for preventing the bottle body 10 and the bottle cap having anti-counterfeit function 100 from being retrieved, reused and forged illegally. In addition, each data stored in the RFID tag 120 can be obtained via the reader, which is quite convenient and efficient for saving manpower.

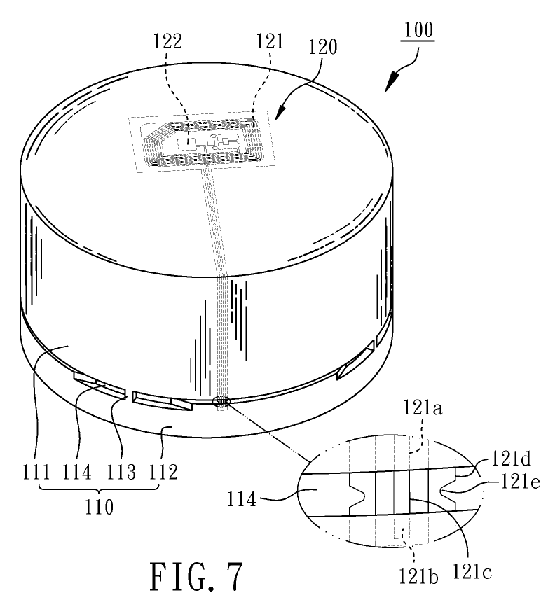

Further, referring to FIG. 7, at least one lateral 121d of the third antenna portion 121c preferably has a gap 121e, the third antenna portion 121e might break and disconnect with the first antenna portion 121a or the second antenna portion 121b via the gap 121e when the bottle cap having anti-counterfeit function 100 is turned to open, hence it remains the same anti-counterfeit and easily differentiating functions as the third antenna portion 121c directly crosses through the interval 140 without being disposed on the joint portion 113.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. A bottle cap having anti-counterfeit function comprising:
a cap body having a cap portion, a ring neck portion and at least one joint portion, wherein there is an interval between the cap portion and the ring neck portion, the joint portion crosses through the interval and is coupled to the cap portion and the ring neck portion; and
an RFID tag disposed at the cap body and having an antenna and a chip electrically connected with the antenna, wherein the antenna has a first antenna portion, a second antenna portion and a third antenna portion connecting with the first antenna portion and the second antenna portion, the first antenna portion and the chip are disposed at the cap portion of the cap body, the second antenna portion is disposed at the ring neck portion of the cap body, the third antenna portion crosses through the interval and bridge connects the first antenna portion and the second antenna portion.

2. The bottle cap having anti-counterfeit function in accordance with claim 1, wherein the third antenna portion is disposed at the joint portion.

3. The bottle cap having anti-counterfeit function in accordance with claim 1, wherein the cap portion has a first surface and a second surface, the first antenna portion and the chip are fixed between the first surface and the second surface.

4. The bottle cap having anti-counterfeit function in accordance with claim 3, wherein the first antenna portion and the chip are fixed between the first surface and the second surface by molding method.

5. The bottle cap having anti-counterfeit function in accordance with claim 1, wherein the cap portion has a first surface and a second surface, the first antenna portion and the chip are fixed on the second surface.

6. The bottle cap having anti-counterfeit function in accordance with claim 1, wherein the ring neck portion has a third surface and a fourth surface, the second antenna portion is fixed between the third surface and the fourth surface.

7. The bottle cap having anti-counterfeit function in accordance with claim 6, wherein the second antenna portion is fixed between the third surface and the fourth surface by molding method.

8. The bottle cap having anti-counterfeit function in accordance with claim 1, wherein the ring neck portion has a third surface and a fourth surface, the second antenna portion is fixed on the fourth surface.

9. The bottle cap having anti-counterfeit function in accordance with claim 2, wherein the joint portion has a fifth surface and a sixth surface, the third antenna portion is fixed between the fifth surface and the sixth surface.

10. The bottle cap having anti-counterfeit function in accordance with claim 9, wherein the third antenna portion is fixed between the fifth surface and the sixth surface by molding method.

11. The bottle cap having anti-counterfeit function in accordance with claim 2, wherein the joint portion has a fifth surface and a sixth surface, the third antenna portion is fixed on the sixth surface.

12. The bottle cap having anti-counterfeit function in accordance with claim 1, wherein at least one lateral of the third antenna portion has a gap.

13. A bottle disposing a bottle cap having anti-counterfeit function comprising:
a bottle body; and
a bottle cap having anti-counterfeit function comprising:
a cap body disposed at the bottle body and having a cap portion, a ring neck portion and at least one joint portion, wherein there is an interval between the cap portion and the ring neck portion, the joint portion crosses through the interval and couples the cap portion and the ring neck portion; and
an RFID tag disposed at the cap body and having an antenna and a chip electrically connected with the antenna, wherein the antenna has a first antenna portion, a second antenna portion and a third antenna portion connecting with the first antenna portion and the second antenna portion, the first antenna portion and the chip are disposed at the cap portion of the cap body, the second antenna portion is disposed at the ring neck portion of the cap body, the third antenna portion crosses through the interval and bridge connects the first antenna portion and the second antenna portion.

14. The bottle disposing a bottle cap having anti-counterfeit function in accordance with claim 13, wherein the third antenna portion is disposed at the joint portion.

15. The bottle disposing a bottle cap having anti-counterfeit function in accordance with claim 13, wherein the cap portion has a first surface and a second surface, the first antenna portion and the chip are fixed between the first surface and the second surface.

16. The bottle disposing a bottle cap having anti-counterfeit function in accordance with claim 13, wherein the ring neck portion has a third surface and a fourth surface, the second antenna portion is fixed between the third surface and the fourth surface.

17. The bottle disposing a bottle cap having anti-counterfeit function in accordance with claim 14, wherein the joint portion has a fifth surface and a sixth surface, the third antenna portion is fixed between the fifth surface and the sixth surface.

18. The bottle disposing a bottle cap having anti-counterfeit function in accordance with claim 16, wherein the ring neck portion has at least one block protrusion located on the fourth surface.

19. The bottle disposing a bottle cap having anti-counterfeit function in accordance with claim 13, wherein the bottle body has at least one stopper capable of blocking the ring neck portion.
